(19) United States
(12) Patent Application Publication
(10) Pub. No.: US 2008/0018638 A1
(43) Pub. Date: Jan. 24, 2008

(54) ATTACHABLE INFORMATIONAL APPLIANCE

(75) Inventor: Jeffrey M. Bursett, San Diego, CA (US)

Correspondence Address: TILLMAN WRIGHT, PLLC, P.O. BOX 471581, CHARLOTTE, NC, 28247, US

(73) Assignee: Bouncing Brain Innovations Season Two Subsidiary 13, LLC, Charlotte, NC (US)

(21) Appl. No.: 11/829,291

(22) Filed: Jul. 27, 2007

Related U.S. Application Data
(63) Continuation of application No. 10/939,312, filed on Sep. 11, 2004.

(51) Int. Cl. G06F 3/038

(52) U.S. Cl. 345/211

(57) ABSTRACT

An appliance includes an upper sheet, a lower sheet, and a utility member that displays data and information. The upper and lower sheets are attached together in a manner whereby the utility member is supported between the upper lower sheets. The lower sheet is attached to another object. The appliance can be of various sizes, shapes, configurations, and thicknesses depending upon the ornamental and functional tastes of the user of the appliance. The utility member generally performs one or more of the functions of receiving, sending, recording, processing, producing, displaying and other manipulation of data and information related to the wide variety of functions that may be performed by microcomputers and microprocessors. The appliance may include additional features to enhance the capabilities of the utility member and the appliance, as desired by the user of the appliance. The appliance may be permanently or removably attached to the object.

### CROSS-REFERENCE TO RELATED APPLICATION

The present application is a U.S. continuation patent application of, and claims priority under 35 U.S.C. §120 to, U.S. nonprovisional patent application Ser. No. 10/939,312, filed Sep. 11, 2004, which nonprovisional patent application is incorporated by reference herein.

### COPYRIGHT STATEMENT

All of the material in this patent document, including the computer program listing, is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND

The present invention generally relates to an appliance that may perform one or more of the functions of receiving, sending, recording, processing, producing, displaying and other manipulation of data and information, where various embodiments of such appliance may be removably or permanently joined to another object.

There currently exist portable devices that perform functions related to receiving, sending, recording, processing, producing, displaying and other manipulation of data and information. Some of these devices are designed to fasten around an object, such as a body part (for example, the wrist or ankle) of a person wearing the device. In other cases, the devices are standalone items, without a convenient means for attaching the devices to another object. There are instances, however, when neither type of device may be appropriate for the desired use. For example, it may be more desirable to attach the device to an object worn, used by, or positioned in close proximity to a person, rather than strapping the device around a portion of the person's body. This may be true for a number of reasons, such as the safety of the person and the desire to essentially make the device a part of the object for functional or aesthetic reasons. It may also be desirable to permanently attach the device to the object in some cases, while in other cases it may be more desirable to removably attach the device to the object. In addition, there are times when it is desirable for the device to also act as a communication medium. For example, it may be desirable to have a message or logo printed on the device for advertising or promotional purposes. Further, it may be desirable for the device to have a pleasing, ornamental appearance in accordance with the taste of the user of the device. It may also be desirable that the device be inexpensive in some cases and disposable in other cases. Also, it may be desirable for the device to be lightweight or waterproof. In all cases, the device must be resilient enough to withstand the environment in which the device is required to operate.

### SUMMARY

The present invention is directed to an appliance that meets the needs discussed above in the Background Section. As described in greater detail below, the present invention, when used for its intended purposes, has many advantages over other devices known in the art, as well as novel features that result in a new appliance and new methods that are not anticipated, rendered obvious, suggested, or even implied by any prior art devices or methods, either alone or in any combination thereof.

Generally, the present invention relates to an appliance that may be permanently attached to an object in some embodiments or removably attached to an object in other embodiments. In a first version of the present invention, the appliance is comprised of a lower sheet, an upper sheet, a utility member, sheet attachment means, and object attachment means. The lower sheet generally has a lower sheet top surface and a lower sheet bottom surface opposite the lower sheet top surface. The upper sheet generally has an upper sheet top surface and an upper sheet bottom surface opposite the upper sheet top surface. The utility member performs one or more functions and displays data and information, as described in more detail below. The sheet attachment means, which is described in more detail below, is used to attach the upper sheet bottom surface to the lower sheet top surface in a manner so that the utility member is supported between the upper sheet and the lower sheet. The object attachment means, which is described in more detail below, is used to join the lower sheet bottom surface to the surface of an object.

In this first version of the invention, the upper sheet and the lower sheet may be of almost any shape. For example, the upper sheet and the lower sheet may each be in the approximate shape of a circle, ellipse, oval, square, rectangle, parallelogram, diamond, swirl, swoosh, spiral, crescent, arc, coil, curl, curve, loop, annulus, rainbow, wave, trapezoid, triangle, pentagon, hexagon, octagon, company logo or trademark, animate object, inanimate object, or almost any other decorative or functional shape or combination of shapes depending upon the taste of the user of the appliance. In addition, the upper sheet and the lower sheet may be of the same approximate size, shape and configuration or may be of different sizes, shapes and configurations. Similarly, the upper sheet and the lower sheet may be of the same approximate thickness or may be of different thicknesses. Preferably, the thickness of the appliance is between 0.005 inch and one inch. The upper sheet and the lower sheet may also be of almost any size adapted for the proposed use of the appliance, but the maximum dimension of the upper sheet and the lower sheet, as measured across the surface of the upper sheet and lower sheet, respectively, is preferably between two inches and twelve inches. In the preferred embodiment of this first version of the invention, the minimum dimension of the upper sheet and the minimum dimension of the lower sheet, when measured along the top or bottom surfaces of the upper sheet and lower sheet in the area adjacent to the utility member, respectively, are greater than the maximum dimension of the utility member supported between the upper sheet and lower sheet, so that the utility member is completely covered by and sealed between the upper sheet and the lower sheet.

In some embodiments of this first version of the invention, the lower sheet is comprised of a rigid, semi-rigid, or flexible material. In other embodiments of this first version of the invention, the upper sheet and lower sheet may be comprised of any combination of flexible or semi-rigid materials. In other embodiments of this version of the invention, the lower sheet is comprised of two or more layers of material that are attached together using lower layer attachment means, which are described in more detail below. These layers may be of the same approximate size, shape and configuration or may be of different sizes, shapes and configurations. Similarly, these layers may be of the same approximate thickness or may be of different thicknesses. In other embodiments of this first version of the invention, the upper sheet may be comprised of two or more layers of material that are attached together using upper layer attachment means, which are described in more detail below. These layers may be of the same approximate size, shape and configuration or may be of different sizes, shapes and configurations. Similarly, these layers may be of the same approximate thickness or may be of different thicknesses. Thus, in various embodiments of this first version of the invention, the appliance may have an ornamental appearance, as when the upper sheet and the lower sheet, or their respective layers, if any, or any combination of upper sheet, lower sheet, and their respective layers, are comprised of materials of different thicknesses, different sizes, different shapes, different types, different colors, and any combination thereof. In other embodiments of this first version of the invention, all or a portion of the upper sheet or lower sheet may be comprised of a transparent material.

The upper sheet and the lower sheet may be constructed of almost any suitable rigid, semi-rigid, or flexible materials currently known in the art or developed in the art in the future. In some embodiments of this first version of the invention, the upper sheet and the lower sheet are comprised of a waterproof material. In other embodiments of this first version of the invention, the upper sheet and the lower sheet, or the layers comprising the upper sheet or the lower sheet or both, are comprised of a polymer material, such as polyester, vinyl, polyimide, polyethylene napthalate, polycarbonates, polyester-polycarbonate blends, or a similar polymer or combinations of such polymers. In addition, in some embodiments of this first version of the invention, the sheet attachment means, as well as the upper layer attachment means or the lower layer attachment means or any combination of such means, are comprised of an adhesive material, and preferably a waterproof adhesive material. In other embodiments, the sheet attachment means, as well as the upper layer attachment means or the lower layer attachment means or any combination of such means, are comprised of heating a portion of the upper sheet and a portion of the lower sheet in a manner so that the heated portions fuse together.

In other embodiments of this first version of the invention, the upper sheet or the lower sheet or both, or one or more of their respective layers, may have a message, trademark, service mark, trade name, or other word, symbol, ornamental design, or expression or any combination of the foregoing printed on, incorporated in, or otherwise affixed to the upper sheet, the lower sheet, or both the upper sheet and the lower sheet. In such embodiments, the appliance may thus also be used to communicate an advertising, promotional, inspirational, personal, or other message to persons observing the appliance. The appliance may also have an aesthetically pleasing appearance as a result of printed, affixed or incorporated ornamental indicia.

In some embodiments of this first version of the invention, the object attachment means allows the appliance to be removably attached to the surface of an object. For example, the object attachment means may be hook and loop fasteners (VELCRO), magnetic attraction, natural surface attraction (such as static electrification), or any other means suitable for removably attaching the lower sheet bottom surface of the appliance to the surface of an object. In other embodiments of this first version of the invention, the object attachment means enables the appliance to be permanently attached to the surface of an object. For example, the object attachment means may be a layer of adhesive material, such as glue, adhesive, or adhesive tape or combinations thereof, on the lower layer bottom surface or other suitable means to permanently attach the appliance to the surface of an object. A more preferred object attachment means is an adhesive transfer tape or acrylic pressure-sensitive adhesive backed with a poly-coated layflat release liner that can be peeled away to provide access to the adhesive material on the lower sheet bottom surface. The preferred object attachment means for joining the appliance to the object is dependent upon the construction of the appliance, the nature of the object to which the appliance is being permanently attached, the anticipated use of the appliance—object combination, and other factors.

In this first version of the invention, the utility member of the appliance is comprised of one or more electronic processors, one or more display elements, and one or more circuit elements connecting the one or more electronic processors and the one or more display elements so that the one or more electronic processors communicate electronically with the one or more display elements. These one or more electronic processors, one or more display elements, and one or more circuit elements are supported between the lower sheet and the upper sheet when the lower sheet and the upper sheet are attached together using the sheet attachment means. In some embodiments of this first version of the invention, the appliance also comprises at least one electronic data storage medium and electronic circuit elements to connect such electronic data storage media to one or more of the electronic processors.

In various embodiments of this first version of the invention, the utility member may perform almost any function and any combination of functions performed by compact, portable electronic devices currently known in the art or that may be developed in the art in the future. For example, in some embodiments, the utility member may perform time-related functions, such as date, day of week, calendar, time, time zone, elapsed time, stopwatch and other similar functions. In other embodiments, the utility member may perform functions similar to those of a radio frequency transmitter or receiver or both. In other embodiments, the utility member may act as a device to receive, record, store, process, play, display and perform other functions commonly performed by devices employing MP3 files. In still other embodiments, the utility member may be a device that receives, stores, processes, displays and transmits data and information of any kind capable of being processed by a microcomputer. For example, in some embodiments the utility member may be capable of receiving, storing, processing, displaying and transmitting physiological data (such as blood pressure, pulse, and body temperature), data related to distance and speed (such as distance traveled, estimated time of arrival, and time en route), and data related to natural phenomena (such as times of sunset/sunrise, ocean tides, phases of the moon, and eclipses). Further, in some embodiments the utility member may perform functions related to receiving, storing, processing, displaying, playing, and transmitting wireless communications, such as cellular telephone, cellular paging, wireless internet access, wireless email, instant messaging, and other similar functions. In yet other embodiments, the utility member may perform functions related to receiving, recording, storing, processing, displaying, playing, and transmitting data and information related to the system commonly known as GPS (global positioning system), such as data and information related to geographical position, altitude, speed, heading, time en route, route taken, planned route, and other information commonly associated with “moving map” GPS devices. In still other embodiments, the utility member may perform functions related to smart cards. The utility member may also have a camera incorporated in other embodiments. It is to be noted, however, that the above description of functions that may be performed by the utility member is not exclusive. Instead, such description is only exemplary; the utility member may be adapted to perform almost any function commonly performed by microcomputers and microprocessors, and combinations of such functions, currently existing or that may be developed in the relevant art in the future.

In various embodiments of this first version of the invention, the one or more electronic processors comprising the utility member may be comprised of one or more integrated circuits, printed circuits, and hybrid circuits or any combination of such circuits. In addition, passive and active circuit components may be used in conjunction with one or more of such circuits where the functions to be performed by the utility member require such components. All such circuits may be constructed of a rigid, semi-rigid, or flexible substrate material. The type of circuit to be used in any embodiment is generally dependent upon the type of function or functions to be performed by the utility member and the nature of the use of the appliance (for example, a flexible circuit may be used where flexibility is required across the surface of the appliance). In some embodiments of this first version of the invention, all of the processor-related functions of the utility member are performed by a single electronic processor. In other embodiments, the various processor-related functions of the utility member are performed by separate electronic processors or combinations of electronic processors. The preferred number of electronic processors comprising the utility member depends upon the function or functions to be performed by the utility member and other factors.

In the various embodiments of this first version of the invention, the one or more display elements comprising the utility member may be of almost any type of miniature, portable display device that is capable of receiving data and information from the one or more processors and displaying such data and information in a format that may be optically observed. For example, the one or more display elements may be LED (light emitting diode), LCD (liquid crystal display), touch screen LCD, plasma, electronic paper, or another type of display currently known in the art or that may be developed in the art in the future. Preferably, at least one display element is an LCD display. The number of display elements is dependent upon the number of functions to be performed by the utility member, the taste of the user of the appliance, and other factors. For example, where the utility member performs time, tide and GPS related functions, the utility member may have one display element to display the time and tide information and another display element to display the GPS related data and information. Alternatively, a single display element can display all data and information in a static or an alternating format. It is to be noted that the displaying surface of the one or more display elements is directed toward the upper sheet and all or part of the portion of the upper sheet adjacent to such displaying surface is either transparent, transparent and in the shape of a lens, or a part of such portion is cut away to allow viewing of the displaying surface of each display element.

In the various embodiments of this first version of the invention, the one or more electronic processors and the one or more display elements comprising the utility member are connected by one or more circuit elements. In some embodiments, the one or more circuit elements are direct electrical contacts between leads on the circuits comprising the one or more electronic processors and leads on the one or more display elements. This is the preferred circuit element connecting an electronic processor and a display element where the configuration of the utility member provides for it. In other embodiments, the one or more circuit elements are electrically conductive connectors, such as electrically conductive wires, ribbons or ink or combinations of such connectors. These are the preferred circuit elements in cases where direct electrical contacts between leads are not available.

In order for the utility member to perform its functions, various embodiments of this first version of the invention comprise additional elements necessary to perform such functions. Thus, some embodiments of this version of the invention further comprise a power source, which provides electrical power necessary for operation of the utility member. Some of these embodiments include a battery as the power source, power reduction means to decrease the consumption of electrical power by the utility member, and means to recharge the power source. Other embodiments include a photoelectric cell as a power source. Some other embodiments further comprise control input means, which enable the user of the appliance to control or provide other input regarding the various functions performed by the utility member. Still other embodiments further comprise one or more communications elements, which allow the utility member to electronically communicate with other devices. Yet other embodiments further comprise a microphone, a speaker, or both, which enable the utility member to send and receive sound information. And other embodiments further comprise sensors, which enable the utility member to acquire data and information. In each case, one or more circuit elements are used to connect such additional elements to the other components of the utility member.

A second version of the present invention generally relates to the same as the first version of the invention described above, except that the utility member is comprised of a mechanical mechanism, rather than an electronic one, used to produce and display data and information. For example, in one embodiment of the second version of the invention, the utility member is comprised of a casing having a flat timepiece mechanism inside, so that the utility member of the appliance performs the same functions as a conventional mechanical wristwatch. In other embodiments of this version of the invention, the utility member acts as a mercury-based thermometer.

As described in more detail below, the appliance successfully meets all of the requirements described in the Background section above. For example, in some embodiments of the invention, the appliance may be removably attached to the surface of an object. In other embodiments, the appliance may be permanently attached to the surface of an object. In either case, it is not necessary for the appliance to be fastened around the object and the appliance can essentially become a part of the object while attached to the object. In some circumstances, this may provide enhanced safety for the person using the appliance. In addition, the appliance of the present invention may act as a communication medium for advertising, promotional and other purposes by having messages and designs printed on, affixed to, or incorporated into the appliance. The construction of the appliance may also be lightweight and have a pleasing, ornamental design in accordance with the taste of the user of the appliance. In some embodiments, the appliance can be inexpensive, so that it may be disposed of once its use is no longer desired. In other embodiments, the appliance is hermetically sealed, so that it may be used in environments where liquids or harsh conditions are present without damage to the appliance and its utility member. The appliance may also be constructed in a manner so that it is resilient enough to withstand the environment in which it is required to operate.

There has thus been outlined, rather broadly, the more primary features of the present invention. There are additional features that are also included in the various embodiments of the invention that are described hereinafter and that form the subject matter of the claims appended hereto. In this respect, it is to be understood that the invention is not limited in its application to the details of construction and to the arrangements of the components set forth in the following description or illustrated in the following drawings. This invention may be embodied in the form illustrated in the accompanying drawings, but the drawings are illustrative only and changes may be made in the specific construction illustrated and described within the scope of the appended claims. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

The foregoing summary, as well as the following description, will be better understood when read in conjunction with the appended drawings, in which:

FIG. 1A is a plan view of a first embodiment of the first version of the invention from above the top surface of the upper sheet of the appliance.

FIG. 1B is a cross-sectional elevation view of the embodiment of the invention illustrated in FIG. 1A, taken along the line 1B-1B in FIG. 1A.

FIG. 1C is an exploded view of the utility member of the embodiment of the invention illustrated in FIG. 1A and FIG. 1B.

FIG. 2A is a plan view of another embodiment of the first version of the invention from above the top surface of the upper sheet of the appliance.

FIG. 2B is a perspective view of the embodiment of the first version of the invention illustrated in FIG. 2A, wherein the appliance is joined to a cylindrical object (which is not a part of the invention).

FIG. 3A is a plan view of another embodiment of the first version of the invention from above the top surface of the upper sheet of the appliance.

FIG. 3B is a plan view of the embodiment of the first version of the invention illustrated in FIG. 3A, with the upper sheet removed from the appliance, such view being from above the top surface of the lower sheet of the appliance.

FIG. 4A is a plan view of another embodiment of the first version of the invention from above the top surface of the upper sheet of the appliance.

FIG. 4B is a cross-sectional elevation view of the embodiment of the invention illustrated in FIG. 4A, taken along the line 4B-4B in FIG. 4A.

FIG. 5A is a plan view of another embodiment of the first version of the invention from above the top surface of the upper sheet of the appliance.

FIG. 5B is a cross-sectional elevation view of the embodiment of the invention illustrated in FIG. 5A, taken along the line 5B-5B in FIG. 5A.

FIG. 6 is a plan view of another embodiment of the first version of the invention from above the top surface of the upper sheet of the appliance.

FIG. 7A is a plan view of another embodiment of the first version of the invention from above the top surface of the upper sheet of the appliance.

FIG. 7B is a cross-sectional elevation view of the embodiment of the invention illustrated in FIG. 7A, taken along the line 7B-7B in FIG. 7A.

FIG. 8A is a plan view of another embodiment of the first version of the invention from above the top surface of the upper sheet of the appliance.

FIG. 8B is a cross-sectional elevation view of the embodiment of the invention illustrated in FIG. 8A, taken along the line 8B-8B in FIG. 8A.

FIG. 9A is a plan view of an embodiment of the display element of the first version of the invention from above the top surface of the display element, wherein the display element is displaying tide-related information.

FIG. 9B is a plan view of an embodiment of the display element of the first version of the invention from above the top surface of the display element, wherein the display element is displaying temperature-related information.

FIG. 9C is a plan view of an embodiment of the display element of the first version of the invention from above the top surface of the display element, wherein the display element is displaying weather-related information.

FIG. 9D is a plan view of an embodiment of the display element of the first version of the invention from above the top surface of the display element, wherein the display element is displaying GPS-related information.

FIG. 9E is a plan view of an embodiment of the display element of the first version of the invention from above the top surface of the display element, wherein the display element is displaying electronic organizer-related information.

### DETAILED DESCRIPTION

Reference will now be made in detail to the preferred aspects, versions and embodiments of the present invention, examples of which are illustrated in the accompanying drawings. While the invention will be described in conjunction with the preferred aspects, versions and embodiments, it is to be noted that the aspects, versions and embodiments are not intended to limit the invention to those aspects, versions and embodiments. On the contrary, the invention is intended to cover alternatives, modifications and equivalents, which may be included within the spirit and scope of the invention as defined by the appended claims.

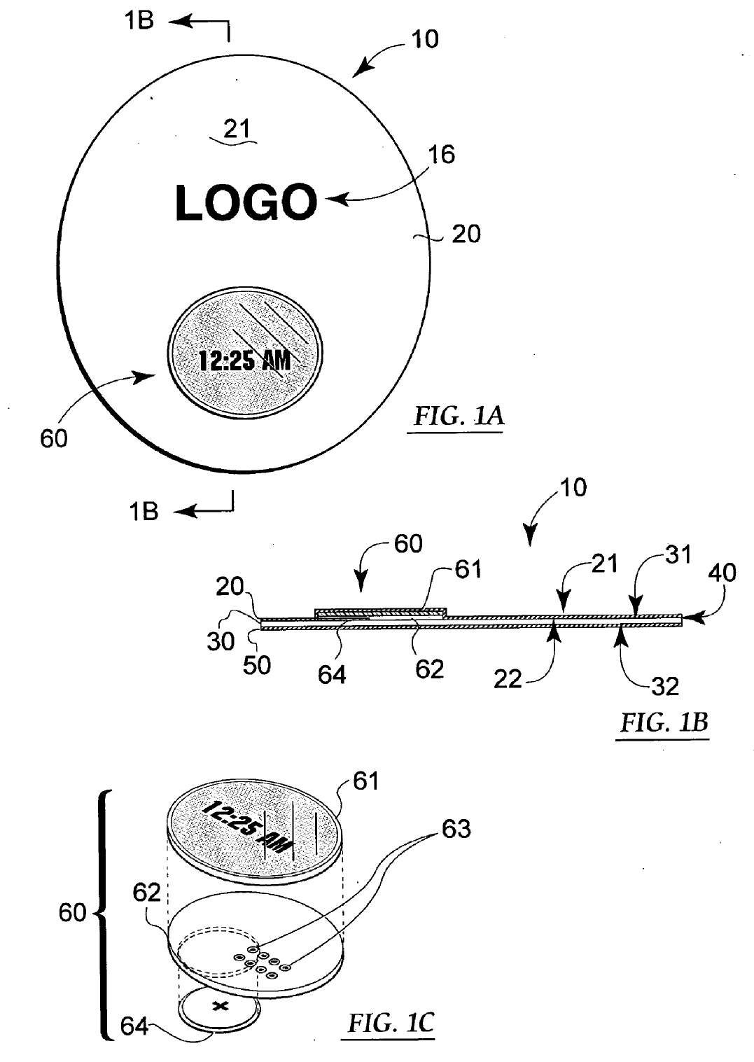

One embodiment of a first version of the present invention is illustrated in FIG. 1A through FIG. 1C. FIG. 1A is a plan view of this embodiment of the invention from above the top surface of the appliance 10. FIG. 1B is a cross-sectional elevation view of the appliance illustrated in FIG. 1A, taken along the line 1B-1B in FIG. 1A. The appliance 10 of this embodiment is comprised of an upper sheet 20, a lower sheet 30, sheet attachment means 40, object attachment means 50, and a utility member 60. The lower sheet 30 generally has a lower sheet top surface 31 and a lower sheet bottom surface 32 opposite the lower sheet top surface 31. The upper sheet 20 generally has an upper sheet top surface 21 and an upper sheet bottom surface 22 opposite the upper sheet top surface 21. The sheet attachment means 40, which is described in more detail below, is used to attach the upper sheet bottom surface 22 to the lower sheet top surface 31 in a manner so that the utility member 60 is supported between the upper sheet 20 and the lower sheet 30. The object attachment means 50, which is described in more detail below, is used to permanently or removably join the lower sheet bottom surface 32 to the surface of an object, which is not shown in this illustration. The utility member 60 performs one or more of the functions of receiving, sending, recording, processing, producing, displaying and other manipulation of data and information, as described in more detail below.

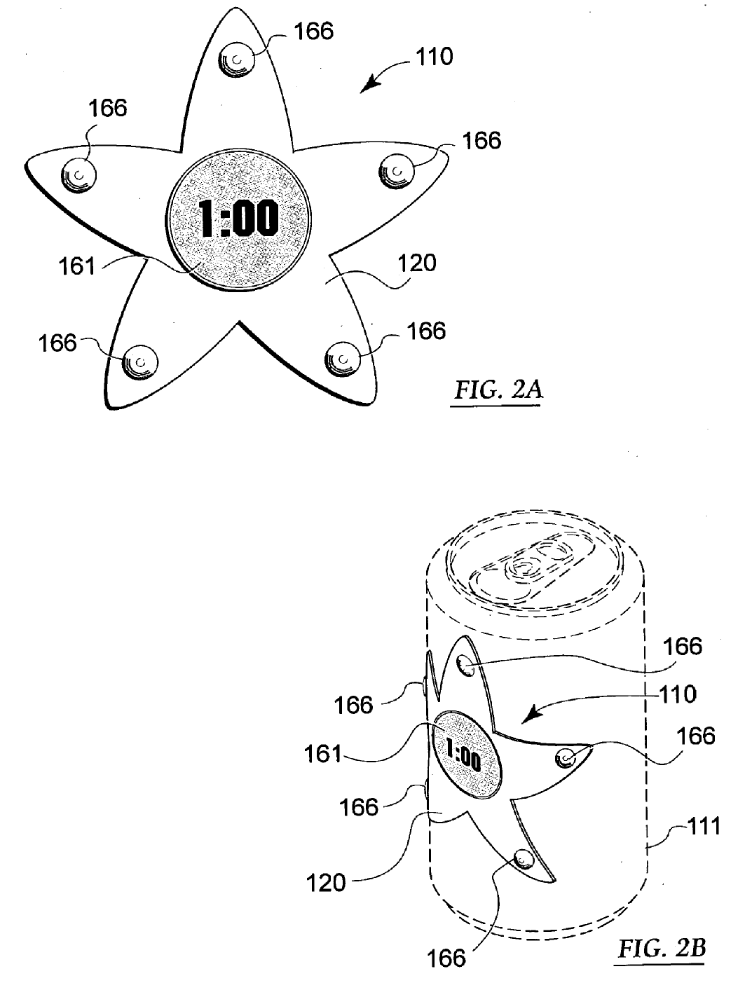

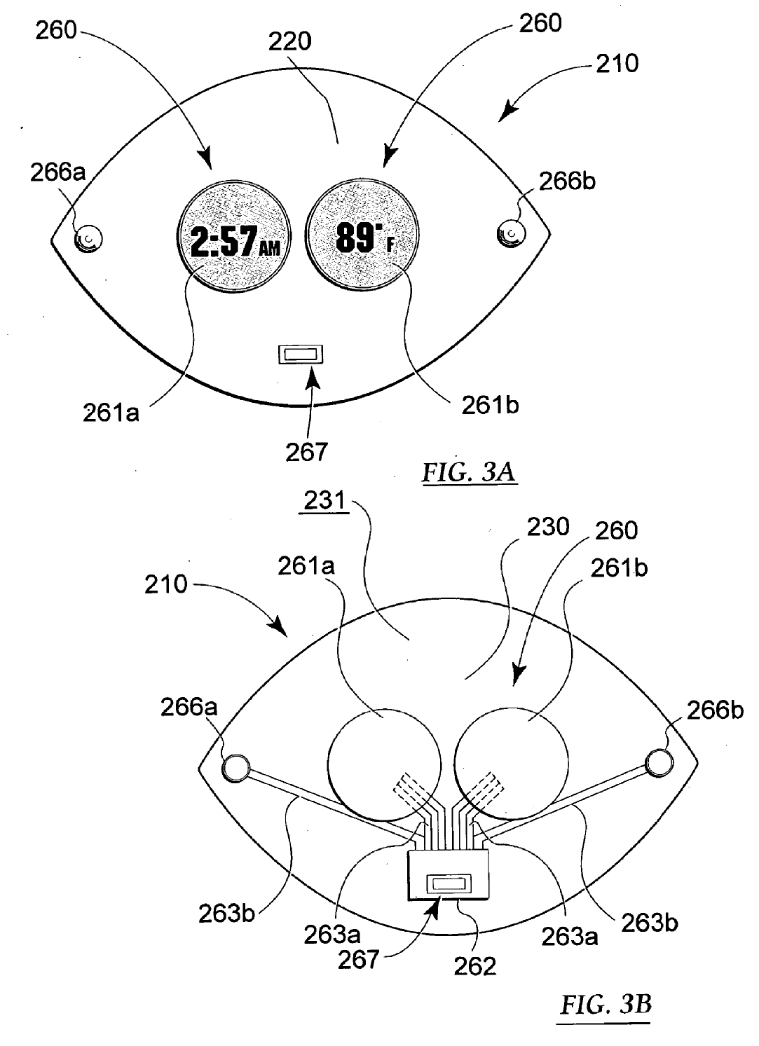

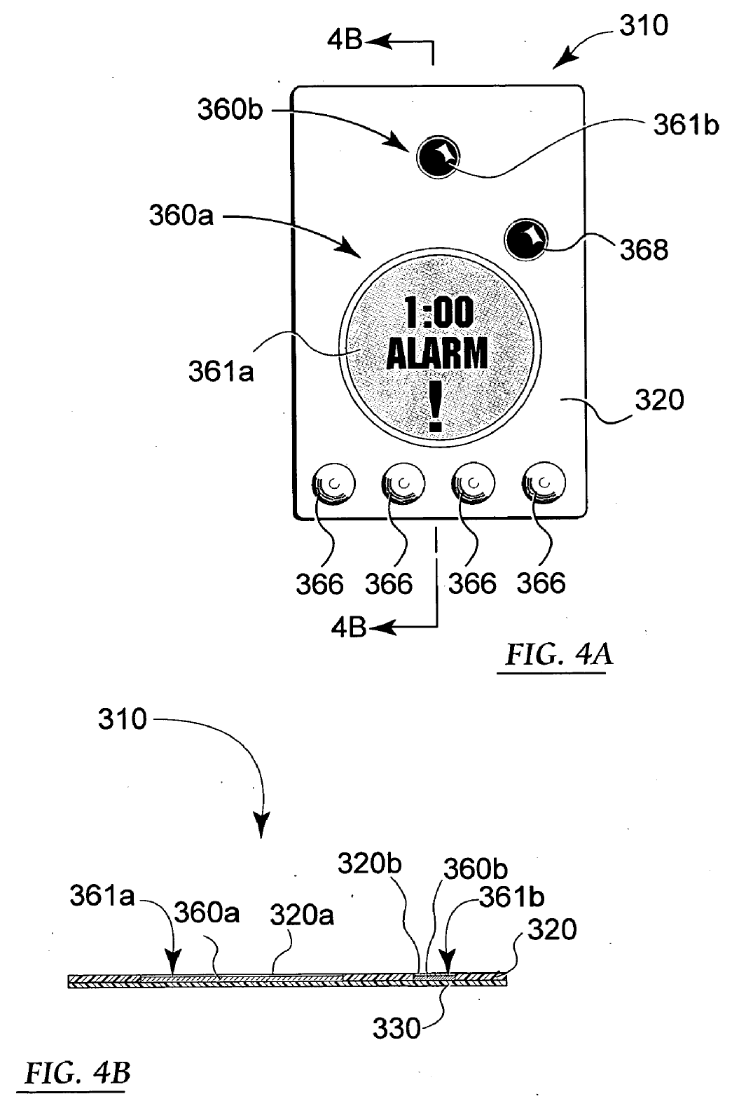

In the embodiment of the first version of the invention illustrated in FIG. 1A through FIG. 1C, the upper sheet 20 and the lower sheet 30 are generally elliptical in shape. In other embodiments of the first version of the invention, the upper sheet and lower sheet may be of almost any form or shape, such as forms and shapes approximating a circle, ellipse, oval, square, rectangle, parallelogram, trapezoid, triangle, pentagon, hexagon, octagon, diamond, swirl, swoosh, spiral, crescent, arc, coil, curl, curve, loop, annulus, rainbow, wave, animate object, inanimate object, company logo or trademark, or almost any other decorative or functional form or shape or combination of forms and shapes depending upon the taste of the user of the appliance. For example, in the embodiment of the first version of the invention illustrated in FIG. 2A and FIG. 2B, the upper sheet 120 and the lower sheet (which is not illustrated, but is of the same shape, configuration and size of the upper sheet 120) of the appliance 110 are approximately in the shape of a star (or flower) having five points. Another example is the embodiment of the first version of the invention illustrated in FIG. 3A and FIG. 3B, in which the shape of the upper sheet 220 and the lower sheet 230 of the appliance 210 is as illustrated in FIG. 3A and FIG. 3B. Yet another example is the embodiment of the first version of the invention illustrated in FIG. 4A and FIG. 4B, in which the upper sheet 320 and the lower sheet 330 of the appliance 310 are rectangular in shape, as illustrated in FIG. 4A. It is to be noted that in the embodiment of the invention illustrated in FIG. 1A through FIG. 1C, the upper sheet 20 and the lower sheet 30 are both of approximately the same size and shape and are configured so that the designated shape (approximately an ellipse) is the only one observed when the appliance 10 is viewed from above the top surface 21 of the upper sheet 20 or the bottom surface 32 of the lower sheet 30 of the appliance 10. The same is also true of the embodiments of the invention illustrated in FIG. 2A through FIG. 4B—the upper sheet 120, 220, 320 and the lower sheet of each appliance 110, 210, 310, respectively, are both of approximately the same size and shape and are configured so that the designated shape illustrated is the only one observed when the appliance 110, 210, 310 is viewed from above the top surface of the upper sheet 120, 220, 320 or the bottom surface of the lower sheet of the appliance 110, 210, 310.

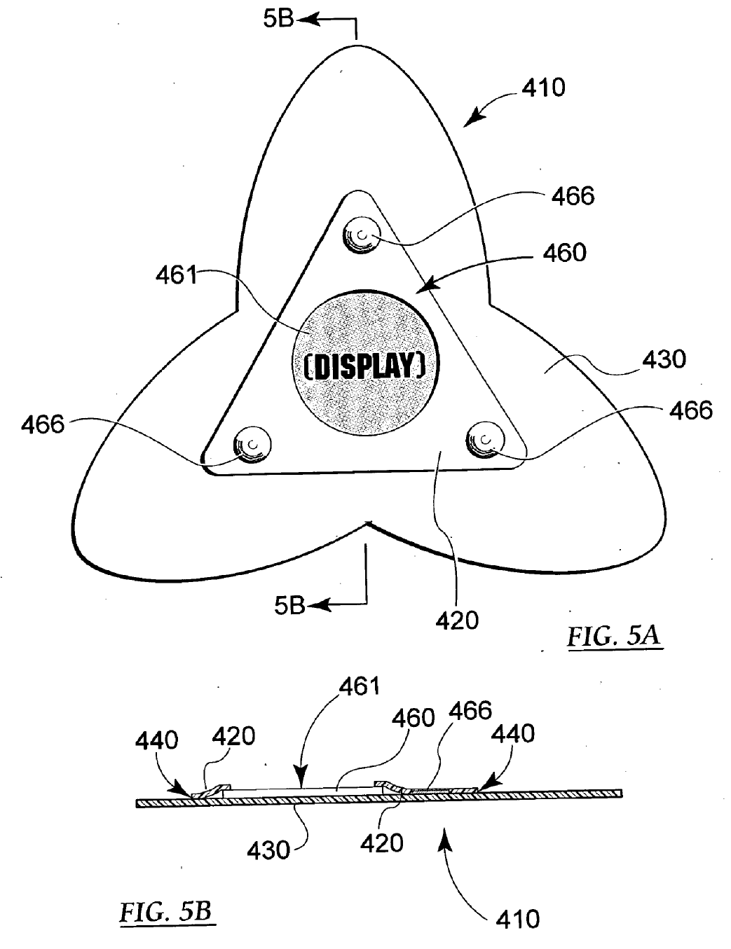

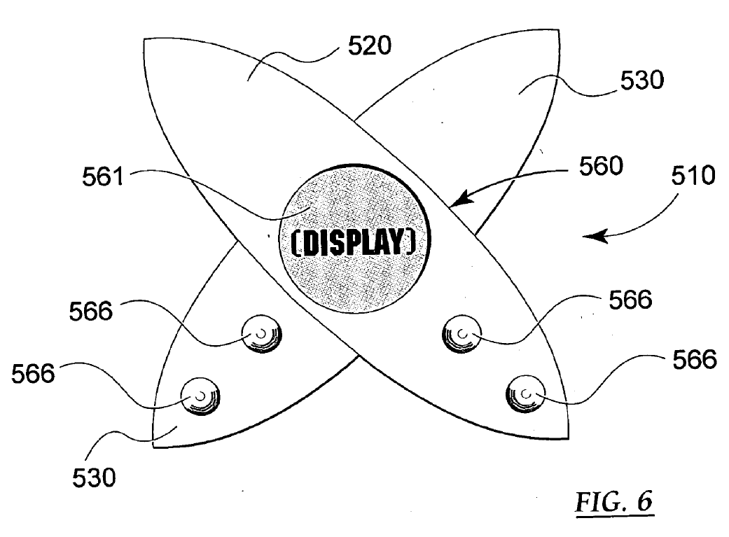

In other embodiments of the first version of the invention, however, the upper sheet and the lower sheet may be of almost any variety of different sizes, shapes and configurations. For example, in the embodiment of the first version of the invention illustrated in FIG. 5A and FIG. 5B, the upper sheet 420 of the appliance 410 is generally triangular in shape, while the lower sheet 430 is in the generally three-lobed shape illustrated in FIG. 5A. In this embodiment, the upper sheet 420 is of a different size and is also of a different shape from the lower sheet 430. Another example is the embodiment of the first version of the invention illustrated in FIG. 6, in which the upper sheet 520 and the lower sheet 530 of the appliance 510 are both of approximately the same size and in the approximate shape of a surfboard. In this embodiment, however, the upper sheet 520 and the lower sheet 530 are configured in a manner so that they form two crossed surfboards, rather than a single surfboard, when observed from above or below the appliance 510. As is readily noted, there are many possible shapes, sizes and configurations and combinations of shapes, sizes and configurations of the upper sheet and lower sheet comprising the present invention, all of which are to be considered within the spirit and scope of the invention as defined by the appended claims. The upper sheet and the lower sheet in each embodiment of this first version of the invention may also be of almost any size adapted for the proposed use of the appliance, but the maximum dimension of the upper sheet and the lower sheet, when measured along the top or bottom surfaces of the upper sheet and lower sheet respectively, is preferably between two inches and twelve inches. In the preferred embodiments of this first version of the invention, as is also illustrated in the embodiment of FIG. 5A and FIG. 5B, the minimum dimension of the upper sheet 420 and the minimum dimension of the lower sheet 430, when measured along the top or bottom surfaces of the upper sheet 420 and lower sheet 430 in the area adjacent to the utility member 460 are greater than the maximum dimension of the utility member 460 supported between the upper sheet 420 and lower sheet 430, so that the utility member 460 is completely covered by the upper sheet 420 and the lower sheet 430 when the upper sheet 420 and the lower sheet 430 are attached together by the sheet attachment means 440. More preferably, as is also illustrated in the embodiment of FIG. 5A and FIG. 5B, the utility member 460 is hermetically sealed between the upper sheet 420 and the lower sheet 430 when the upper sheet 420 and the lower sheet 430 are attached together by the sheet attachment means 440.

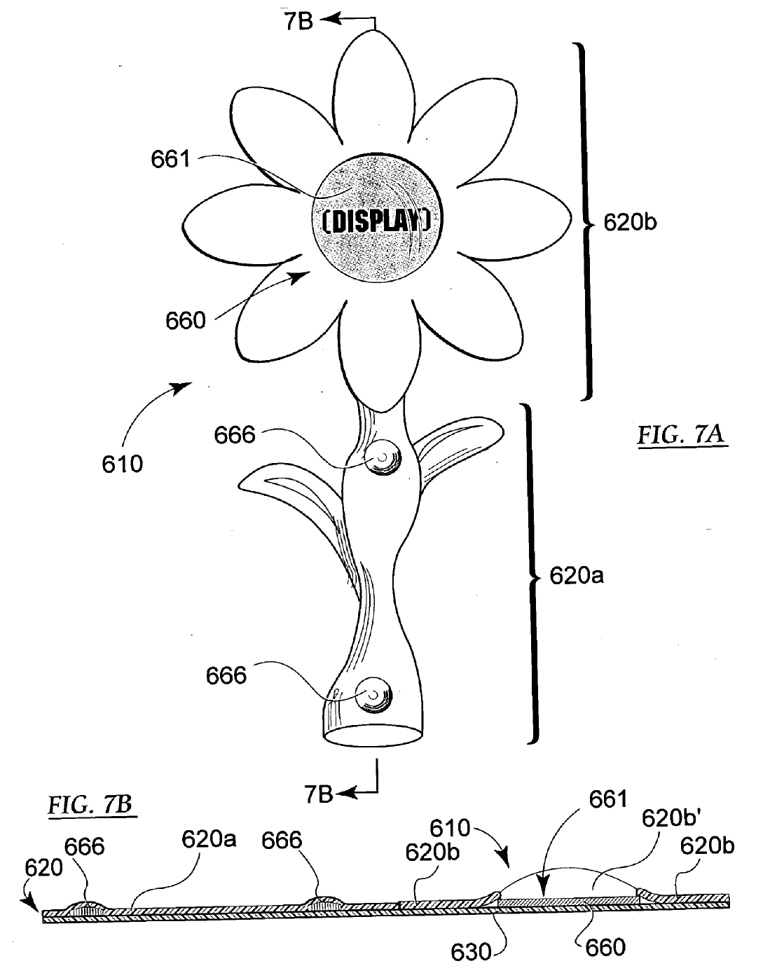

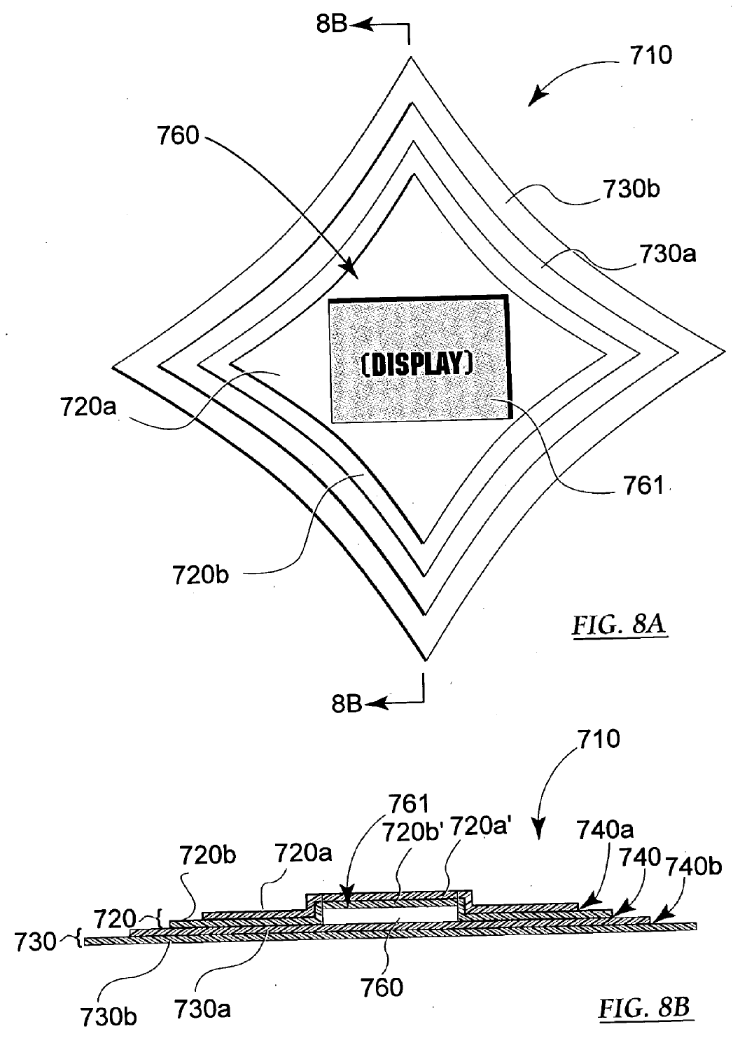

In other embodiments of this first version of the invention, as illustrated in FIG. 8A and FIG. 8B, the lower sheet 730 is comprised of two or more layers 730a, 730b of material that are attached together using lower layer attachment means 740b, which are described in more detail below. As illustrated in FIG. 8A, these layers 730a, 730b are of the same approximate shape and configuration, but of a different size. In other embodiments of this first version of the invention in which the lower sheet has two or more layers, the layers may be of the same size, shape and configuration or may be of any combination of different sizes, shapes and configurations. In other embodiments of this first version of the invention, the upper sheet may also be comprised of two or more layers of material that are attached together using upper layer attachment means, which are described in more detail below. In different embodiments, these layers may also be of the same approximate size, shape and configuration or may be of any combination of different sizes, shapes and configurations. For example, in the embodiment of the first version of the invention illustrated in FIG. 8A, the upper sheet 720 of the appliance 710 is comprised of two layers 720a, 720b having approximately the same shape and configuration, but being of a different size. As is the case with the upper sheet and lower sheet in this first version of the invention, there are many possible shapes, sizes and configurations and combinations of shapes, sizes and configurations of the layers comprising the upper sheet and lower sheet of the present invention. Similarly, some embodiments of this first version of the invention may have an upper sheet having two or more layers while the lower sheet has a single layer. In other embodiments, the appliance may have an upper sheet having a single layer, while the lower sheet has two or more layers. In other embodiments, the upper sheet, the lower sheet, or both, and any layers comprising the upper sheet, the lower sheet, or both, may be molded to fit the various components comprising the utility member. For example, in the embodiment of this first version of the invention illustrated in FIG. 4A and FIG. 4B, the thickness of the portions 320a and 320b of the upper sheet 320 in the area immediately adjacent to the utility members 360a and 360b, respectively, is less than the thickness of the other portions of the upper sheet 320, so that when the upper sheet 320 is attached to the lower sheet 330, the thickness of the appliance 310 is approximately uniform over the entire surface of the appliance 310. As another example, in the embodiment of this first version of the invention illustrated in FIG. 1A through FIG. 1C and FIG. 8A and FIG. 8B, the upper sheet 20, 720 is molded into a shape conforming to the utility member 60, 760, respectively, so that the upper sheet 20, 720 fits tightly against the utility member 60, 760. As yet another example, in the embodiment of this first version of the invention illustrated in FIG. 7A and FIG. 7B, a part of the stem portion of the upper sheet 620a is molded into a dome-type shape conforming to the shape of the dome switches 666, so that such portion of the upper sheet 620a immediately adjacent to the dome switches 666 is slightly raised relative to the remainder of the upper sheet 620a. In other embodiments, the upper sheet and the lower sheet may each have a layer that over molds the upper sheet and the lower sheet, respectively, in which such over molding layers are attached together at their outer edges so that such over molding layers encapsulate the remaining portions of the upper sheet and the lower sheet, together with the utility member supported within them. All of these embodiments are to be considered within the spirit and scope of the invention as defined by the appended claims. In all of these embodiments involving layers, as illustrated in FIG. 8A and FIG. 8B, the utility member 760 continues to be supported by the upper sheet 720 and the lower sheet 730 when they are attached together using the sheet attachment means 740.

In addition, the upper sheet and the lower sheet of this first version of the invention may be of the same approximate thickness or may be of different thicknesses. For example, in the embodiment of the invention illustrated in FIG. 1A through FIG. 1C, the thickness of the upper sheet 20 is less than the thickness of the lower sheet 30. In contrast, in the embodiment of the invention illustrated in FIG. 7A and FIG. 7B, the flower portion of the upper sheet 620b generally has a thickness greater than the thickness of the lower sheet 630. Referring to the embodiment of the invention illustrated in FIG. 1A through FIG. 1C as an example, the upper sheet 20 preferably has a thickness of between 0.005 inch and 0.5 inch, while the lower sheet 30 preferably has a thickness of between 0.005 inch and 0.5 inch. In embodiments of this first version of the invention wherein the upper sheet has two or more layers, the layers comprising the upper sheet may be of the same approximate thickness or may be of different thicknesses similarly, in embodiments of this first version of the invention wherein the upper sheet has two or more layers, the layers comprising the upper sheet may be of the same approximate thickness or may be of different thicknesses. The thickness of the upper sheet and the thickness of the lower sheet in each embodiment of this first version of the invention depend upon the anticipated use of the appliance, the materials used to construct the appliance, the individual tastes of the user of the appliance, and other factors. For example, in the embodiment of the invention illustrated in FIG. 8A and FIG. 8B, the layers 720a, 720b, 730a, 730b are each of approximately the same thickness. Referring to the embodiment of the invention illustrated in FIG. 8A and FIG. 8B as an example, the combined thicknesses of the layers 720a, 720b comprising the upper sheet 720 is between 0.005 inch and 0.5 inch, and the combined thicknesses of the layers 730a, 730b comprising the lower sheet 730 is between 0.005 inch and 0.5 inch. More preferably, the thickness of the appliance 710 (and for the appliance in all embodiments of this first version of the invention) is between 0.005 inch and one inch.

In this first version of the invention, the materials comprising the upper sheet and the lower sheet of the appliance are dependent upon the anticipated use of the appliance and the individual taste of the user of the appliance. For example, where the appliance 10 in the embodiment of the invention illustrated in FIG. 1A through FIG. 1C is designed for attachment to objects having a flat surface, both the upper sheet 20 and the lower sheet 30 may be comprised of a rigid or semi-rigid material or any combination of rigid and semi-rigid materials. In such cases, the upper sheet 20 may also be comprised of a flexible material. As another example, in the embodiment of the invention illustrated in FIG. 2A and FIG. 2B, where the appliance 110 is designed for attachment to a curved surface, such as a cylindrical object 111 (which is not a part of the claimed invention), both the upper sheet 120 and the lower sheet (which is not illustrated, but is of the same shape, configuration and size of the upper sheet 120) may be comprised of a flexible material. In such cases, a semi-rigid material may also be used. Thus, in various embodiments of this first version of the invention, the lower sheet and the upper sheet may each be comprised of a rigid, semi-rigid, or flexible material or any combination of flexible, semi-rigid and rigid materials. In embodiments of this first version of the invention wherein the upper sheet has two or more layers, the individual layers comprising the upper sheet may be comprised of flexible, semi-rigid or rigid materials or any combination of such materials. Similarly, in embodiments of this first version of the invention wherein the lower sheet has two or more layers, the individual layers comprising the lower sheet may be comprised of flexible, semi-rigid or rigid materials or any combination of such materials. It is also to be noted that the appliance in the various embodiments of this first version of the invention may be adapted to be joined to the surface of objects having almost any shape, such as flat surfaces, curved surfaces, and combinations of such surfaces. All of these embodiments are to be considered within the spirit and scope of the invention as defined by the appended claims.

The type of material used to construct the upper layer and the lower layer in the various embodiments of this first version of the invention is dependent upon the anticipated use of the appliance, the desired flexibility of the appliance, the desired aesthetic appearance of the appliance in accordance with the individual taste of the user of the appliance, and other factors. Almost any suitable rigid, semi-rigid, or flexible material currently known in the art or developed in the art in the future may be used for such purposes. For example, in embodiments of this first version of the invention where rigidity or semi-rigidity is desired, as may be the case with the appliance 10 illustrated in FIG. 1A through FIG. 1C where the appliance 10 is designed to be attached to a flat surface, the upper sheet 20 and the lower sheet 30 may be comprised of wood, metal, cloth, fabric, paper, glass, plastic, polymer, rubber, synthetic materials, natural materials, and any other suitable rigid or semi-rigid materials currently known in the art or discovered in the art in the future. In such cases, it is preferred that such materials be waterproof, and if the anticipated use requires it, be resistant to other fluids and environmental hazards. More preferably, in such cases, the lower sheet 30 is comprised of a semi-rigid plastic or polymer material (e.g., polyvinyl chloride, polyester, ABS, propylene or polystyrene), and the upper sheet 20 is comprised of a flexible polymer material, such as those described below in this paragraph. On the other hand, where flexibility of the appliance is desired, as in the appliance 110 illustrated in FIG. 2A and FIG. 2B, examples of materials comprising the upper sheet 120 and the lower sheet (which is not illustrated, but is of the same shape, configuration and size of the upper sheet 120) include paper, cloth, fabric, rubber, metal foils, plastics, polymers, synthetic flexible materials, natural flexible materials, and any other suitable flexible material currently known in the art or discovered in the art in the future. In such cases, it is preferred that such materials be waterproof, and if the anticipated use requires it, be resistant to other fluids and environmental hazards. It is also preferred, in such cases, that both the upper sheet 120 and the lower sheet (which is not illustrated, but is of the same shape, configuration and size of the upper sheet 120) be comprised of a flexible polymer material, such as polyester (such as MYLAR sold by Dupont Teijin Films), vinyl (such as FLEXMARK PLV-400-FW sold by FLEXcon), polyimide, polyethylene napthalate (such as TEDLER sold by ICI), polycarbonates (such as LEXAN sold by General Electric), polyester-polycarbonate blends, or a similar polymer or combinations of such polymers. More preferably, in such cases, both the upper sheet 120 and the lower sheet (which is not illustrated, but is of the same shape, configuration and size of the upper sheet 120) are comprised of a polyester film or a vinyl polymer film. Most preferred in such cases, both the upper sheet 120 and the lower sheet (which is not illustrated, but is of the same shape, configuration and size of the upper sheet 120) are comprised of a polyester film. In all cases, the materials used to construct the upper sheet and the lower sheet in all embodiments of the invention are also preferably free from shrinkage over their useful life, have chemical and temperature resistance adequate for the anticipated use environment, and have sufficient strength and tear resistance adequate for their intended use of supporting the utility member within the upper sheet and lower sheet and joining the appliance to the joined object.

It is also to be noted that different materials may be used in construction of the upper sheet and the lower sheet in different embodiments of this first version of the invention. For example, as may be the case with the appliance 10 illustrated in FIG. 1A through FIG. 1C where the appliance 10 is designed to be attached to a flat surface, the upper sheet 20 may be comprised of polyester and the lower sheet 30 may be comprised of polypropylene. In other embodiments of the invention, the upper sheet and the lower sheet may each be comprised of the same material. For example, in the embodiment of the invention illustrated in FIG. 2A and FIG. 2B, the upper sheet 120 and the lower sheet (which is not illustrated, but is of the same shape, configuration and size of the upper sheet 120) may each be comprised of polycarbonate. In other embodiments, both the upper sheet and the lower sheet may each be comprised of more than one material. For example, in the embodiment of the invention illustrated in FIG. 7A and FIG. 7B, the appliance 610 may have a lower layer 630 comprised of a polyester-polycarbonate blend and an upper layer 620 comprised of a stem portion 620a constructed of a fabric coated with a water resistant material and a flower portion 620b constructed of a vinyl polymer. In the embodiments of the invention in which the upper sheet is comprised of two or more layers, the layers comprising the upper sheet may be comprised of the same material or any combination of different materials. Similarly, in the embodiments of the invention in which the lower sheet is comprised of two or more layers, the layers comprising the lower sheet may be comprised of the same material or any combination of different materials. For example, in the embodiment of the invention illustrated in FIG. 8A and FIG. 8B, the appliance 710 may have a lower layer 730 comprised of a layer 730b of cloth having a water resistant coating on it and a layer 730a of polyester, and an upper layer 720 having layers 720a and 720b constructed of a vinyl polymer. Alternatively, another embodiment of the invention illustrated in FIG. 8A and FIG. 8B may have the upper layer 720 comprised of a layer 720a of polycarbonate and a layer 702b of a vinyl polymer. In addition, in various embodiments of the invention each layer of either the upper sheet or the lower sheet may be constructed of more than one material in the same manner that the upper layer 620 of the appliance 610 illustrated in FIG. 7A and FIG. 7B is comprised of more than one material. As is readily noted, there are many possible materials and combinations of materials that may be used to construct the upper sheet (and any of its layers) and the lower sheet (and any of its layers) of the various embodiments of this first version of the invention, all of which are to be considered within the spirit and scope of the invention as defined by the appended claims.

It is also to be noted that in this first version of the invention, the upper sheet (and any of its layers), the lower sheet (and any of its layers), or both the upper sheet and the lower sheet (and any of their layers) may be of one color or may be of multiple colors or multiple shades of the same color or combinations of colors and shades. In other embodiments of this version of the invention, all or a portion of the upper sheet, the lower sheet, or both the upper sheet and the lower sheet, may be comprised of a transparent material. Thus, in the appliance 710 of the embodiment of the invention illustrated in FIG. 8A and FIG. 8B, the layer 730b may be black, the layer 730a may be dark gray, the layer 720b may be light gray, and the layer 720a may be white, except for the portions 720a′ and 720b′ of the layers 720a and 720b, respectively, that are adjacent to the utility member 760, which are transparent to allow for viewing of the display element upper surface 761 from above the upper sheet 720 of the appliance 710. Generally, all or part of the portion of the upper sheet 720 adjacent to the utility member 760 must be transparent to allow for viewing of the upper surface of the display element 761 of the utility member 760. Alternatively, a portion of the upper sheet may be cut away to allow for such viewing, but enough of the upper sheet must remain to adequately cover and support the utility member. For example, in the embodiment of the invention illustrated in FIG. 5B, a portion of the upper sheet 420 has been cut away to provide for viewing of the upper surface of the display element 461 of the utility member 460. As yet another alternative, as illustrated in the embodiment of the appliance 610 of FIG. 7A and FIG. 7B, the portion 620b′ of the upper sheet 620b is constructed of a glass or transparent polymer material generally shaped as a lens to facilitate, and in some cases enhance, viewing of the upper surface of the display element 661 of the utility member 660. As is readily noted, there are many possible colors, shades and combinations of colors and shades that may be used to construct the upper sheet (and any of its layers) and the lower sheet (and any of its layers) of the various embodiments of this version of the invention, all of which are to be considered within the spirit and scope of the invention as defined by the appended claims. In addition, in various embodiments of this first version of the invention, the appliance may have an ornamental appearance, as when the upper sheet and the lower sheet, and/or their respective layers, if any, are comprised of materials of different thicknesses, different sizes, different shapes, different types, different configurations, or different colors and shades, or combinations thereof, all of which are to be considered within the spirit and scope of the invention as defined by the appended claims.

Referring again to the embodiment of this first version of the invention illustrated in FIG. 1A through FIG. 1C, the appliance 10 has a logo 16 printed on the upper sheet 20 for advertising or promotional purposes. In other embodiments of this first version of the invention, the appliance may have a message, trademark, service mark, trade name, or other word, symbol, ornamental design, or expression printed on, incorporated in, or otherwise affixed to one or more of the upper sheet, the lower sheet, or their respective layers, if any. In such embodiments, the appliance may thus also be used to communicate an inspirational, personal, or other message to persons observing the appliance. The appliance may also have an aesthetically pleasing appearance as a result of printed, affixed or incorporated ornamental indicia, such as ornamental designs printed on the surface of the appliance.

Referring again to the embodiment of this first version of the invention illustrated in FIG. 1A through FIG. 1C, the sheet attachment means 40 may be any material suitable for permanently attaching the bottom surface 22 of the upper sheet 20 to the top surface 31 of the lower sheet 30. The material used depends upon the type and thickness of the materials comprising the upper sheet 20 and the lower sheet 30, the type and construction of the utility member 60, the anticipated use of the appliance 10, and other factors. Such materials may include glues, adhesives, adhesive tapes, resins, gums, epoxies, acrylics and similar materials currently known in the art or developed in the art in the future. In all cases, the sheet attachment means 40 should preferably be free from shrinkage over its useful life, have temperature resistance adequate for the anticipated use environment, and have adequate adhesive strength for its intended use of permanently attaching the upper sheet 20 to the lower sheet 30 and supporting the utility member 60 between the upper sheet 20 and lower sheet 30. More preferably, the material comprising the sheet attachment means 40 is also waterproof, and if the anticipated use requires it, is resistant to other chemicals, so that the upper sheet 20 and the lower sheet 30 form a hermetic seal around the utility member 60 when the upper sheet 20 and the lower sheet 30 are attached together by the sheet attachment means 40. Most preferably, the sheet attachment means is a permanent acrylic pressure-sensitive adhesive, such as that sold by FLEXcon under the trademark V-29, or another waterproof adhesive material, such as that sold by the 3M Company under the trademark 3M ADHESIVE 200MP. As an alternative, the sheet attachment means 40 may be comprised of a process of heating all or a portion of the upper sheet 20 or all or a portion of the lower sheet 30, or both, in a manner so that all or a portion of the bottom surface 22 of the upper sheet 20 and all or a portion of the top surface 31 of the lower sheet 30 are fused together. For example, the outer edges of the lower sheet 30 and the outer edges of the upper sheet 20 may be heated, followed by pressing the top surface 31 of lower sheet 30 against the bottom surface 22 of the upper sheet 20, so that the heated portions of the upper sheet 20 fuse together with the heated portions of the lower sheet 30. As another example, the top surface 31 of the lower sheet 30 may be placed against the bottom surface 22 of the upper sheet 20 with the utility member 60 between such sheets 20, 30, and then the outer edges of the lower sheet 30 and the outer edges of the upper sheet 20 may be heated in a manner so that the top surface 31 of lower sheet 30 fuses to the bottom surface 22 of the upper sheet 20 in the areas of the heated portions of the upper sheet 20 or the lower sheet 30, or both. In cases where the upper sheet 720 and the lower sheet 730 are comprised of two or more layers, as in the embodiment of the invention illustrated in FIG. 8A and FIG. 8B, the upper layer attachment means 740a, which is used to permanently attach together each of the layers comprising the upper layer 740, and the lower layer attachment means 740b, which is used to permanently attach together each of the layers comprising the upper layer 740, may generally be the same as the sheet attachment means 40 illustrated and discussed above in conjunction with the appliance 10 of FIG. 1A through FIG. 1C. It is also to be noted that each of the upper layer attachment means 740a may be the same as or different from each of the lower layer attachment means 740b, which may both be the same as or different from the sheet attachment means 740. As illustrated in FIG. 8A and FIG. 8B, the sheet attachment means 740 is typically only applied to the areas of the upper sheet 720 and the lower sheet 730 that are adjacent to and attached to one another, and where appropriate, attached to the surface of the utility member 760. The sheet attachment means 740 may be used, but need not necessarily be used, in the areas where the upper sheet 720 and the lower sheet 730 are in contact with the utility member 760. In embodiments of the invention where the sheet attachment means 740 is used in areas in contact with the utility member 760, the sheet attachment means 740 adjacent to the displaying surface of the display element 761 of the utility member 760, as described in more detail below, must also be transparent to allow for viewing of the upper surface of the display element 761 from above the upper sheet 720 of the appliance 710.

Referring again to the embodiment of this first version of the invention illustrated in FIG. 1A through FIG. 1C, the object attachment means 50 is comprised of hook and loop fasteners (commonly sold under the trademark VELCRO), which enables the appliance to be removably attached to an object. In other embodiments of this first version of the invention, the object attachment means 50 may be any means suitable for removably attaching the bottom surface 32 of the lower sheet 30 to the object. For example, the object attachment means may also be magnetic (such as where the lower sheet or a layer comprising the lower sheet is constructed of a material having magnetic properties), natural surface attraction (such as static electrification), or any other means currently known in the art or developed in the art in the future that are suitable for removably attaching the lower sheet 30 bottom surface 32 of the appliance 10 to the surface of an object. The preferred object attachment means 50 in these embodiments depends upon the construction of the appliance 10 (for example, the materials and rigidity of construction of the appliance 10), the nature of the object to which the appliance 10 is being removably attached (for example, smooth rigid surface of a surfboard or flexible fabric surface of a running shirt), the expected use of the appliance—object combination (for example, attachment to the exterior surface of a computer monitor or exterior windshield of an automobile), the individual taste of the user of the appliance 10, and other factors. In other embodiments of this first version of the invention, the object attachment means 50 may be any means suitable for permanently attaching the bottom surface 32 of the lower sheet 30 to the object. For example, permanent object attachment means may be glue, adhesive, adhesive tape, gums, resins, epoxies, acrylics or any other means currently known in the art or developed in the art in the future that are suitable for permanently attaching the lower sheet 30 bottom surface 32 of the appliance 10 to the surface of an object. The preferred object attachment means 50 for permanently attaching the appliance 10 to the object is also dependent upon the construction of the appliance 10, the nature of the object to which the appliance 10 is being permanently attached, the expected use of the appliance—object combination, and other factors. More preferably, the permanent object attachment means 50 is an adhesive layer applied to the bottom surface 32 of the lower layer 30, where the adhesive layer is overlaid by backing material (such as paper) that can be peeled away from the adhesive layer on the bottom surface 32 of the lower layer 30. An example of this means is the acrylic pressure-sensitive adhesive sold by FLEXcon under the trade name V-29 backed with a poly-coated layflat release liner sold by FLEXcon under the trade name 90 PFW, or similar adhesive and backing materials.

In the embodiment of this first version of the invention illustrated in FIG. 1A through FIG. 1C, the utility member 60 of the appliance 10 is comprised of a display element 61, an electronic processor 62, and circuit elements 63 connecting the electronic processor 62 and the display element 61, so that the electronic processor 62 communicates electronically with the display element 61. FIG. 1C is an exploded view of the utility member 60 that is incorporated as a part of the appliance 10 illustrated in FIG. 1A and FIG. 1B. The electronic processor 62, the display element 61, and the circuit elements 63 are supported between the lower sheet 30 and the upper sheet 20 when the lower sheet 30 and the upper sheet 20 are attached together using the sheet attachment means 40.

In various embodiments of this first version of the invention, the utility member 60 may perform almost any function and any combination of functions performed by compact, portable electronic devices currently known in the art or that may be developed in the art in the future. For example, in some embodiments of the invention, the utility member 60 may perform time-related functions, such as date, day of week, calendar, time, time zone, elapsed time, stopwatch and other similar functions. In other embodiments, the utility member 60 may perform functions similar to those of a radio frequency transmitter or receiver or both, such as by receiving, processing, displaying, recording, playing and transmitting radio signals commonly associated with AM (amplitude modulation), FM (frequency modulation), short wave, ham, amateur, aviation, emergency services, and other radio frequencies. In other embodiments, the utility member 60 may act as a device to receive, record, store, process, play, display and perform other functions commonly performed by devices employing MP3 files. In still other embodiments, the utility member 60 may be a device that receives, stores, processes, displays and transmits data of any kind capable of being processed by a microcomputer. For example, in some embodiments the utility member 60 may be capable of receiving, storing, processing, displaying and transmitting physiological data (such as blood pressure, pulse, and body temperature), data related to distance and speed (such as distance traveled, estimated time of arrival, and time en route), and data related to natural phenomena (such as times of sunset/sunrise, ocean tides, phases of the moon, and eclipses). Further, in some embodiments the utility member 60 may perform functions related to receiving, storing, processing, displaying, playing, and transmitting wireless communications, such as cellular telephone, cellular paging, wireless internet access, wireless email, instant messaging, and other similar functions. In yet other embodiments, the utility member 60 may perform functions related to receiving, recording, storing, processing, displaying, playing, and transmitting data and information related to the system commonly known as GPS (global positioning system), such as data and information related to geographical position, altitude, speed, heading, time en route, route taken, planned route, and other information commonly associated with “moving map” GPS devices. In still other embodiments, the utility member 60 may perform functions related to smart cards. Also, the utility member 60 may have a camera incorporated therein that records, receives, stores, processes, displays, plays, and transmits data and information related to video or stationary images, or both, in a variety of wavelengths, including optical and infrared wavelengths. The utility member 60 may also perform functions related to visual, audible, and vibrating alarms. All of the above functions may be performed and displayed in almost any language, and the utility member 60 may perform functions related to translation of one or more languages. It is to be noted, however, that the above description of functions that may be performed by the utility member 60 is not exclusive. Instead, such description is only exemplary; the utility member 60 may be adapted to perform almost any function and any combination of functions commonly performed by microcomputers and microprocessors currently existing or that may be developed in the relevant art in the future.

In the embodiment of the invention illustrated in FIG. 1A through FIG. 1C, all of the processor-related functions of the utility member 60 are performed by a single electronic processor 62. In other embodiments of the invention, however, the various processor-related functions of the utility member may be performed by separate electronic processors or combinations of electronic processors. The preferred number of electronic processors comprising the utility member depends upon the function or functions to be performed by the utility member. For example, where time and physiological data are received, stored, produced, processed and transmitted by the utility member, the time-related functions may be performed by one electronic processor and the physiological-related functions may be performed by another electronic processor. Generally, and referring again to the embodiment of the invention illustrated in FIG. 1A through FIG. 1C as an example, the one or more electronic processors 62 may be comprised of one or more integrated circuits, printed circuits, and hybrid circuits or any combination of such circuits currently known in the art or developed in the art in the future. In addition, passive and active circuit components may be used in conjunction with one or more of such circuits where the functions to be performed by the utility member 60 require such components. Such circuits may be constructed of a rigid, semi-rigid, or flexible substrate material. The upper sheet 20 or the lower sheet 30 or both may also act as a substrate material, with one or more of such circuits being deposited on a portion of the surface of the upper sheet 20 or the lower sheet 30 or any combination of such surfaces. In other embodiments of this first version of the invention, one or more of the layers comprising the upper sheet or the lower sheet or both, or any combination of such layers, may act as a substrate material, with one or more of such circuits being deposited on one or more surfaces of such layers. The type of circuit to be used in any embodiment of the invention is generally dependent upon the type of function or functions to be performed by the utility member 60 and the nature of the use of the appliance 10 (for example, a flexible circuit may be used where flexibility is required across the surface of the appliance 10). The electronic processor 62 may also include circuits necessary to electronically operate a display element 61. For example, the electronic processor 62 may include a driver circuit, which is used to develop the voltages appropriate to activate and deactivate the pixels of a display element 61 comprised of a liquid crystal display (LCD) or to activate and deactivate a display element comprised of a light emitting diode (LED). The electronic processor 62 may also include a polarity switcher at the output of the driver circuit that selects whether the row or column electrode of an LCD display element 61 is to receive the positive polarity, while a row/column selector switch determines which specific row/column pair of an LCD display element 61 receives the voltages produced by the polarity switch and the driver circuit. In some embodiments of this first version of the invention, the appliance 10 may also comprise one or more additional electronic data storage media, which may be comprised of almost any compact, portable data storage media currently known in the art or that may be developed in the art in the future. For example, such data storage media may include one or more additional memory boards or integrated circuits or a part of the integrated circuit or circuits comprising the electronic processor 62. Alternatively, in the event such devices are reduced to an appropriate size, such electronic data storage media may also include an optical storage device, a hard drive device, or combinations of such devices, in electronic communication with the circuits comprising the electronic processor 62. As another alternative, the data storage media may include one or more memory cards, such as flash memory cards, that may be removably attached to the appliance 10 using means discussed in more detail below. Preferably, the electronic processor 62 is a modular integrated circuit or combination of integrated circuits adapted to perform the functions desired of the utility member 60. An example of such integrated circuits is the Camera Phone System Chipsets sold by Sanyo Electric Co., Ltd.

In the embodiment of the invention illustrated in FIG. 1A through FIG. 1C, the utility member 60 is comprised of one display element 61, which receives data and information from the electronic processor 62 and optically displays such data and information in a format that may be observed from above the surface of the upper sheet 20 of the appliance 10. In other embodiments of the invention, the appliance may have two or more display elements. The number of display elements is dependent upon the number of functions to be performed by the utility member, the information to be displayed, the taste of the user of the appliance, and other factors. For example, in the embodiment of this first version of the invention illustrated in FIG. 3A and FIG. 3B, the appliance 210 has two display elements 261a and 261b, in which display element 261a displays information related to time functions and display element 261b displays information related to temperature functions. Alternatively, a single display element may display all data and information in a static or an alternating format, which may or may not be controlled by a control input means. It is to be noted that in the embodiments of the invention illustrated in FIG. 1A through FIG. 8B, the displaying surface of the one or more display elements 61, 161, 261a, 261b, 361a, 361b, 461, 561, 661, 761 is directed toward the upper sheet 20, 120, 220, 320, 420, 520, 620b, 720, respectively. In other embodiments, the displaying surface of the display element may be viewed from below the bottom surface of the appliance. In addition, in some embodiments of the invention, as illustrated in FIG. 5A and FIG. 5B, a portion of the upper sheet 420 adjacent to the displaying surface of the display element 461 of the utility member 460 may be cut away to allow for viewing of the display element 461 from above the upper sheet 420 of the appliance 410. Alternatively, as described above in connection with the embodiment of the invention illustrated in FIG. 8A and FIG. 8B, the portions 720a′ and 720b′ of the layers 720a and 720b, respectively, comprising the upper sheet 720 may be transparent to allow for viewing of the upper surface of the display element 761 from above the upper sheet 720 of the appliance 710, and as described above in connection with the embodiment of the invention illustrated in FIG. 7A and FIG. 7B, the portion 620b′ of the upper sheet 620b adjacent to the utility member 660 may be constructed of a glass or transparent polymer material generally shaped as a lens to allow for, or enhance viewing of, the upper surface of the display element 661.

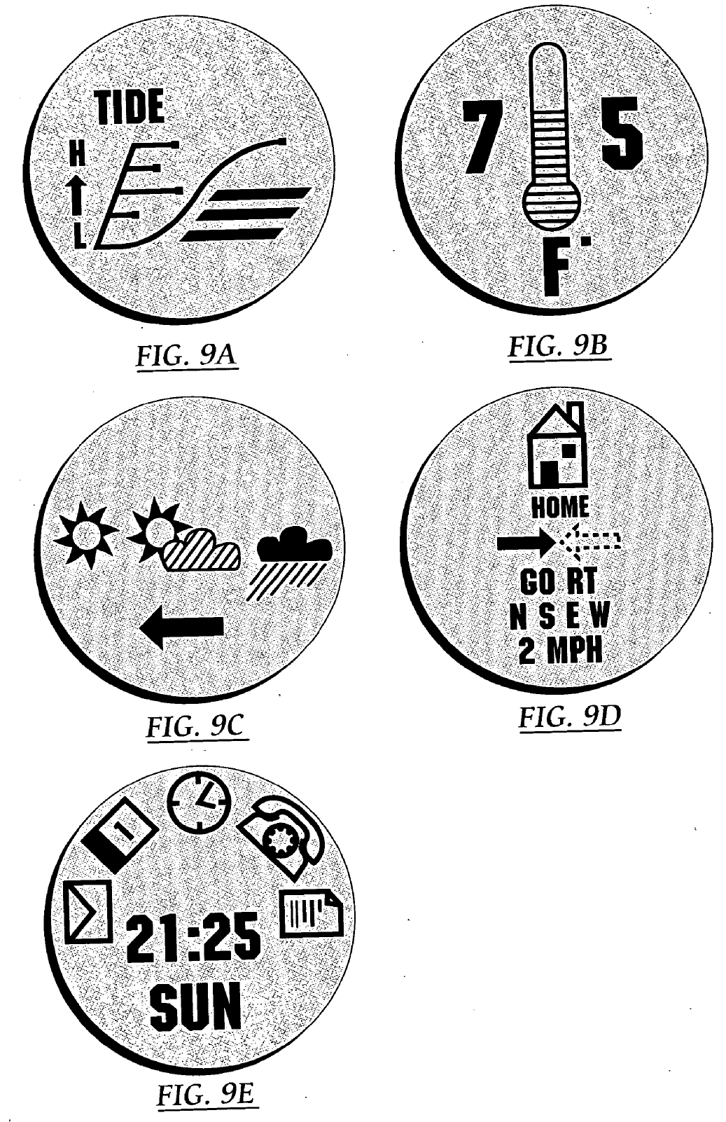

In the embodiments of the invention illustrated in FIG. 1A through FIG. 8B, the display element 61, 161, 261a, 261b, 361a, 461, 561, 661, 761 is comprised of a liquid crystal display (LCD). In other embodiments of this first version of the invention, the one or more display elements comprising the utility member may be of almost any type of miniature, portable display device currently known in the art or developed in the art in the future that is capable of receiving data and information from the one or more electronic processors and displaying such data and information in a format that may be optically observed. For example, each display element may be comprised of LED, LCD, plasma, electronic papers (e.g., GYRICON, choleteric nematic phase transition, and IRIDIGM), and similar types of displays. The type of display element is dependent upon the taste of the user of the appliance, the functions to be performed by the utility member, the information to be displayed by the display element, the expected use of the appliance, and other factors. It is to be noted that more than one type of display element may be used in the various embodiments of the invention. For example, in the embodiment of the invention illustrated in FIG. 4A and FIG. 4B, the appliance 310 has one LCD display element 361a that displays time-related information received from the electronic processor and one LED display element 361b that is activated and blinks when a designated alarm signal is received from the electronic processor. It is also to be noted that the one or more display elements in this first version of the invention may be of almost any shape currently known in the art or developed in the art in the future. For example, the display element 161 of the appliance 110 illustrated in FIG. 2A and FIG. 2B is generally circular in shape, while the display element 761 of the appliance 710 illustrated in FIG. 8A and FIG. 8B is generally rectangular in shape. In addition, in various embodiments of this first version of the invention, the display element may display data and information in any format desired by the user of the appliance. For example, in the embodiments illustrated in FIG. 9A through FIG. 9E, FIG. 9A illustrates a display element providing tide information, FIG. 9B illustrates a display element providing temperature information, FIG. 9C illustrates a display element providing weather trend information, FIG. 9D illustrates a display element providing GPS/compass information, and FIG. 9E illustrates a display element providing electronic organizer information.

Preferably, as illustrated in FIG. 1A through FIG. 8B, the appliance 10, 110, 210, 310, 410, 510, 610, 710 of each embodiment of this first version of the invention has at least one display element 61, 161, 261a, 261b, 361a, 461, 561, 661, 761, respectively, that is comprised of an LCD display. Referring to the embodiment of this first version of the invention illustrated in FIG. 1A through FIG. 1C as an example, the LCD display element 61 may be constructed of rigid, semi-rigid, or flexible materials, such as glass and suitable transparent polymers, such as polyvinyl chloride and polycarbonate. In various embodiments of this first version of the invention, the LCD display element 61 may be comprised of a portion of the upper sheet 20 or the lower sheet 30. The type of material used to construct the LCD display element 61 is dependent upon the anticipated use of the appliance 10, the desired flexibility of the appliance 10, the desired aesthetic appearance of the appliance 10 in accordance with the individual taste of the user of the appliance 10, and other factors. In different embodiments of the invention, the LCD display element 61 may provide information in full-motion video, in static display, in black and white, and in one or more colors and combinations of colors and different shades of the same color. In addition, the LCD display element 61 may be constructed of bi-stable or multi-stable display material, such as a ferroelectric LCD based upon smectic liquid crystals typically of the C phase that exhibit chiral behavior, that will maintain an image when power has been removed. In addition, the LCD display element 61 may be constructed in a manner so that it provides stereoscopic effects, such as images that appear three-dimensional and images that alter their appearance based upon a viewing angle. This type of display is described in U.S. Pat. No. 5,931,764 to Viztec, Inc., which is incorporated herein by reference. Further, the LCD display element 61 may incorporate a “touch screen” feature, so that data may be input into the utility member 60 by touching a portion of the surface of the LCD display element 61. Resistive, projected, surface capacitive, IR, surface wave, and other similar types of LCD displays currently known in the art or developed in the art in the future may be used for this purpose. More preferably, the LCD display element is an LCD utilizing continuous grain silicon technology.

In the various embodiments of this first version of the invention, the one or more electronic processors and the one or more display elements comprising the utility member are connected by one or more circuit elements. For example, in the embodiment of the invention illustrated in FIG. 1A through FIG. 1C, the electronic processor 62 is connected to the display element 61 by circuit elements 63 comprised of direct electrical contact between the leads on the circuits comprising the electronic processor 62 and the leads on the display element 61. In other embodiments of this first version of the invention, the one or more circuit elements may be electrically conductive connectors, such as electrically conductive wires, ribbons, strips, inks and similar connectors and combinations thereof. The preferred circuit elements in these embodiments are electrically conductive ink, which may be printed on any surface or any combination of surfaces of the upper sheet, the lower sheet, or any surface or any combination of surfaces of any layer comprising the upper sheet or lower sheet or both. For example, in the embodiment of this first version of the invention illustrated in FIG. 3A and FIG. 3B, the electronic processor 262 is electrically connected to the display elements 261a, 261b by circuit elements 263a comprised of conductive ink printed on the top surface 231 of the lower sheet 230. The most preferred circuit element connecting an electronic processor and a display element is a direct electrical contact between the electronic processor and the display element.

In order for the utility member to perform its various functions, various embodiments of this first version of the invention comprise additional elements necessary to perform such functions. Thus, some embodiments of this first version of the invention further comprise a power source, which provides electrical power necessary for operation of the utility member. For example, as illustrated in FIG. 1A through FIG. 1C, the utility member 60 also includes a power source 64 to provide electrical energy for operation of the utility member 60. The power source 64 may be comprised of one or more of almost any compact, portable source of electrical energy known in the art or developed in the art in the future, such as a battery. In other embodiments of the invention, the power source may also be comprised of one or more devices that are used to collect solar or other electromagnetic energy and convert such energy to a form appropriate for powering the appliance 10. For example, the power source may be comprised of one or more photoelectric cells fabricated from a silicon compound. The type of power source to be used in any particular embodiment is dependent upon the anticipated use of the appliance 10 and the individual preference of the user of the appliance 10. Preferably, the power source 64 is a flexible thin-film lithium ion battery, such as the thin-film lithium ion battery system sold by Cymbet Corporation under the trademark POWER FAB, for applications where the utility member 60 of the appliance 10 may require flexibility, and preferably a standard disc-type of lithium battery well known in the art and common in powering portable electronic devices for applications where such flexibility is not required. The power source 64 is electronically connected to the electronic processor 62 by one or more of the circuit element types described above. Some of these embodiments may also include power reduction means to decrease the consumption of electrical power by the utility member. An example of such means is described in U.S. Pat. No. 5,931,764 to Viztec, Inc., which is incorporated herein by reference. Other embodiments may also include means to recharge the power source 64, such as the use of direct electrical contacts, RF signals, inductive, solar-galvanostatic, potentiostatic, and other charging means currently known in the art or developed in the art in the future. To accomplish such charging, the utility member 60 may include a regulator control circuit that accepts current and voltage from an external power source for storage in the power source. An example of such means is described in U.S. Pat. No. 5,931,764 to Viztec, Inc., which is incorporated herein by reference. Other embodiments further comprise control input means, which enable the user of the appliance to control or provide other input regarding the various functions performed by the utility member. For example, in the embodiments of this first version of the invention illustrated in FIG. 2A through FIG. 7B, the appliances 110, 210, 310, 410, 510, 610 generally have “buttons” 166, 266a, 266b, 366, 466, 566, 666, respectively, that are comprised of a dome-type or membrane-type of electrical switch. In the case of the embodiment of the invention illustrated in FIG. 3A and FIG. 3B, one button 266a may control the display of various time functions (e.g., time, day of week, date and stopwatch functions), while the other button 266b may control the display of various temperature functions (e.g., current temperature and 24 hour high/low temperatures). Other embodiments of this version of the invention may also use other control input means, which may include almost any compact, portable means to provide data or control input in electronic form that is currently known in the art or that may be developed in the art in the future. Examples include rheostats, potentiometers, switches, relays, touch screen LCD's, and other input means, and combinations of all of the foregoing. The control input means are electronically connected to the electronic processor by one or more of the circuit element types described above. For example, in the embodiment of the invention illustrated in FIG. 3A and FIG. 3B, the buttons 266a, 266b are connected to the electronic processor 262 by circuit elements 263b comprised of electrically conductive ink printed on the top surface 231 of the lower layer 230.

Still other embodiments of this first version of the invention further comprise one or more communications elements, which allow the utility member to communicate with other devices. For example, in the embodiment of the invention illustrated in FIG. 3A and FIG. 3B, the appliance 210 has a communications element 267 in the form of shielded electrical contacts that allow the utility member 260 of the appliance 210 to communicate electronically with other electronic and peripheral devices, such as computers, smart card readers, data storage media, telephones, printers, PDA's, headphones and similar devices and compatible peripheral devices. The communications element 267 may also be comprised of unshielded electrical contacts in other embodiments of the invention. Where the appliance 210 utilizes electrical contacts and the size of such device requires, a passive mechanical adapter may be necessary to connect the appliance 210 to the other device. In other embodiments of this first version of the invention, the communications element 267 may be comprised of an antenna-type of device, such as a wireless inductive loop screen-printed on a surface of the upper sheet 220 or lower sheet 230 of the appliance 210. This type of communications element 267 enables the appliance 210 to communicate wirelessly with other devices using radio and other frequencies, such as is the case with cellular messaging and telephone systems and wireless internet access systems. It also enables the appliance 210 to receive and transmit data and information related to GPS. Yet other embodiments of this first version of the invention further comprise a microphone, a speaker, or both, which enable the utility member to send and receive sound information. For example, in the embodiment of the invention illustrated in FIG. 4A and FIG. 4B, the appliance 310 also has a thin-film flexible piezoelectric speaker 368 that offers multiple-octave sound. A suitable piezoelectric speaker/microphone made of polymer films is described in U.S. Pat. No. 5,115,472, which is incorporated herein by reference. In still other embodiments of this first version of the invention, the appliance may also include an audible or vibrating alarm. Still other embodiments of this first version of the invention further comprise sensors, which enable the utility member to acquire data and information. Examples of such sensors include thermocouples to acquire temperature data, accelerometers to acquire data related to movement (e.g., to collect and display shock, g-force, and pedometer data), piezoelectric polymer films (such as poly vinylidene flouride) to acoustically collect physiological data, sensors to detect pressure changes to collect and display information related to altitude and barometric pressure, sensors to detect electrical and other energy (e.g., for measuring exposure to ultraviolet radiation), and combinations of all of the foregoing. It is to be noted that almost any compact, portable means to detect and collect data and information that are currently known in the art or that may be developed in the art in the future may be used in various embodiments of this first version of the invention. In each case where such additional elements are included as a part of the invention, one or more circuit elements are used to connect such additional elements to the other components of the utility member.

With respect to the first version of the invention, it is also to be noted that the utility member may be comprised of a modular unit that includes an electronic processor, display element, circuit elements, and control input means constructed as a single, compact, integrated unit. Such modular units are well known in the current art. An example of this type of modular unit is the 3.5 digit LCD watch module with 6 flashing icons, Model No. LCD21-2132, sold by EL-TRONIC LTD., Hong Kong.

A second version of the present invention is generally the same as described above for the first version of the invention, except that the utility member is comprised of a mechanical mechanism, rather than an electronic one, used to produce and display data and information. For example, in the embodiment of the second version of the invention illustrated in FIG. 1A through FIG. 1C, the utility member 60 of the appliance 10 may be comprised of a casing having a flat timepiece mechanism inside, so that the utility member 60 of the appliance 10 performs the same functions as a conventional mechanical wristwatch. In other embodiments of this second version of the invention, the utility member may be comprised of almost any compact, thin, portable device that produces and displays information. For example, the utility member 60 may be comprised of a mercury-based thermometer.

The invention may be constructed using a variety of methods. As an example of one such method, in the embodiment of the invention illustrated in FIG. 1A through FIG. 1C, the upper sheet 20 and the lower sheet 30 can each be cut from a piece of polyester film, such as MYLAR. The lower sheet 30 may then be coated with an adhesive, such as FLEXcon V-29 adhesive, which acts as the sheet attachment means 40. Subsequently, the utility member 60 may be placed on the top surface 31 of the lower sheet 30, and the upper sheet 20 may be placed over the utility member 60 onto the top surface 31 of the lower sheet 30 and compressed against the lower sheet 30 until the adhesive adheres to the lower sheet 30 and the upper sheet 20. The hook and loop (VELCRO) object attachment means 50 may then be attached to the bottom surface 32 of the lower layer using an adhesive, such as FLEXcon V-29 adhesive.

What is claimed is:

1. An appliance comprising: (a) a lower sheet, having a lower sheet top surface and a lower sheet bottom surface opposite the lower sheet top surface; (b) an upper sheet, having an upper sheet top surface and an upper sheet bottom surface opposite the upper sheet top surface; (c) a utility member that displays data and information; (d) sheet attachment means to attach the upper sheet bottom surface to the lower sheet top surface in a manner so that the utility member is supported between the upper sheet and the lower sheet; and (e) object attachment means to join the lower sheet bottom surface to the surface of an object; (f) wherein the utility member is comprised of: (i) one or more electronic processors; (ii) one or more display elements; and (iii) one or more circuit elements to connect the one or more electronic processors and the one or more display elements so that the one or more electronic processors communicate electronically with the one or more display elements.

2. The appliance of claim 1, wherein each of the one or more processors displays image data and information on one or more of the one or more display elements.

3. The appliance of claim 1, wherein the utility member performs and displays time-related functions.

4. The appliance of claim 1, wherein the utility member performs and displays functions selected from the group consisting of radio communications, data communications, voice Docket No. 151.11 communications, and combinations thereof.

5. The appliance of claim 1, wherein the utility member performs and displays MP3-related functions.

6. The appliance of claim 1, wherein the utility member performs and displays functions related to physiological data.

7. The appliance of claim 1, wherein the utility member performs and displays functions related to distance and speed.

8. The appliance of claim 1, wherein the utility member performs and displays functions related to natural phenomena.

9. The appliance of claim 1, wherein the utility member performs and displays functions related to the global positioning system.

10. The appliance of claim 1, wherein the utility member performs and displays functions related to smart cards.

11. The appliance of claim 1, wherein the utility member performs and displays functions selected from the group consisting of camera related functions, video related functions, and combinations thereof.

12. The appliance of claim 1, wherein the one or more electronic processors are comprised of microprocessors selected from the group consisting of integrated circuits, printed circuits, hybrid circuits, and combinations thereof.

13. The appliance of claim 1, further comprising at least one electronic data storage medium and one or more circuit elements to connect the at least one electronic data storage medium to the one or more electronic processors.

14. The appliance of claim 1, wherein the one or more display elements are selected from the group consisting of light emitting diode displays, liquid crystal displays, plasma displays, electronic paper displays, and combinations thereof.

15. The appliance of claim 1, wherein at least one of the one or more display elements is comprised of a touch screen liquid crystal display.

16. The appliance of claim 1, wherein the one or more the circuit elements are selected from the group of electrically conductive materials consisting of electrically conductive wire, ribbon, ink, and combinations thereof.

17. The appliance of claim 1, further comprising a power source and one or more circuit elements to connect the power source to the one or more electronic processors.

18. The appliance of claim 17, further comprising means to reduce the power consumption of the utility member.

19. The appliance of claim 17, further comprising means to recharge the power source.

20. The appliance of claim 17, wherein the power source is comprised of at least one battery or at least one photoelectric cell.
